(19) United States
(12) Patent Application Publication
(10) Pub. No.: US 2001/0012055 A1
(43) Pub. Date: Aug. 9, 2001

(54) Article image data marking method and apparatus and gem stone marked with image data

(76) Inventor: Yasuhira Mori, Kanagawa (JP)

Correspondence Address: GREENBLUM & BERNSTEIN, 1941 ROLAND CLARKE PLACE, RESTON, VA, 20191

(21) Appl. No.: 09/745,800

(22) Filed: Dec. 26, 2000

(30) Foreign Application Priority Data
Dec. 27, 1999 (JP) P11-371890
Feb. 4, 2000 (JP) P2000-28238
Nov. 10, 2000 (JP) P2000-343500
Nov. 10, 2000 (JP) P2000-343511

(51) Int. Cl. H04N 7/18; H04N 9/47

(52) U.S. Cl. 348/61

(57) ABSTRACT

The invention gives a buyer of an article (gem stone) such as diamond the highest customer satisfaction by the article with such a scarcest value that there is the only article in the world to an owner. A laser output portion and the article (gem stone) are relatively positioned with respect to each other by a positioning portion 30 such that a laser beam output from the laser output portion 20 comes into a focus on an arbitrary surface of the article (gem stone) 10. On the other hand, digital image data to be marked is obtained by an image data obtaining portion 40. A laser beam control portion 50 causes the laser output portion 20 to operate according to the obtained marking data and applies a laser beam to the surface of the article (gem stone) 10 to thereby mark the digital image data on the surface of the article (gem stone) 10.

### BACKGROUND OF THE INVENTION

The present invention relates to an article image data marking method and an article image data marking apparatus applied to a gem stone such as diamond, for example, and a gem stone marked with image data.

In general, absence of a flaw on a surface is an essential requirement for high quality of various gem stones. Especially in a case of a transparent or translucent gem stone such as diamond, absence of a flaw not only on the surface but also inside proves high quality of the gem stone. Many people buy gem stones such as diamond as a commemoration of an engagement or a commemoration of marriage.

On the other hand, in a case of a ring such as a wedding ring, for example, it is common practice to carve initials of the two people, a date of a wedding, or the like in a back face of the ring as a commemoration.

However, although it is understandable that a carving done in the diamond itself would be the best commemoration to an owner in a case of a gem stone such as diamond, no one wishes beauty of the gem stone is impaired by a flaw on a surface of the gem stone. Therefore, applying of a marking as a commemoration to the gem stone itself such as diamond is not carried out conventionally.

### SUMMARY OF THE INVENTION

It is an object of the present invention to overturn the above conventional common sense and to mark image data as a commemoration on an arbitrary surface of a gem stone such as diamond or in a portion at a necessary inward distance from the surface in such a range as no: to substantially affect quality of the gem stone. As a result, it is possible to provide article image data marking method and apparatus and a gem stone marked with image data which can give a buyer of the gem stone such as diamond the highest customer satisfaction by the gem stone with such a scarcest value that there is the only gem stone in the world to the owner.

In a method for marking predetermined image data on an arbitrary surface of a gem stone according to the invention, a laser beam is applied to the surface while controlling output and an application direction of the laser beam according to the image data. In the method of the invention, the laser beam is controlled so as not to substantially affect quality of the gem stone.

In a method for marking predetermined image data in a portion at a necessary inward distance from an arbitrary surface of a gem stone according to the invention, a laser beam is applied to the portion while controlling output and an application direction of the laser beam according to the image data. Because the laser beam is applied while bringing the laser beam to a focus on the predetermined portion according to the image data in the method of the invention, it is possible to create a marking without substantially damaging the surface.

In an apparatus for marking predetermined image data on an arbitrary surface of an article or in an inner portion of the surface according to the invention, the apparatus comprises an image information obtaining portion for obtaining and editing an image desired by a customer a laser output portion for outputting laser light whose strength and an application direction are controlled for processing, a positioning portion for adjusting relative positions of the laser output portion and the article with respect to each other, and a control portion for controlling the laser output portion and the positioning portion according to the image data and applies the above marking. Because the laser beam is controlled so as not to substantially affect quality of the article, it is difficult for people except concerned ones to find the marking but the concerned people can always find the marking. Therefore, it is possible to provide the marking with high scarcity value.

A system for marking image data in an arbitrary portion of an article according to a desire of a customer according to the invention is the above marking apparatus in which an image information obtaining portion is separated from other components and an image desired by the customer is created and transferred to the system through a telecommunication line. Thus, it is possible to speedily fill an order from the customer.

### BRIEF DESCRIPTION OF THE DRAWINGS

FIG. 1 is a block diagram showing an embodiment of an article image data marking apparatus.

FIG. 2 is an enlarged explanatory view of a support table.

FIG. 3 is a flowchart showing operation of the apparatus in FIG. 1.

FIG. 4 is an explanatory view showing a diamond that is given round brilliant cut as an example of an article (gem stone).

FIG. 5 is an enlarged explanatory view of an essential portion showing an example in which image data is marked on a girdle of the diamond that is given the round brilliant cut.

FIG. 6 is a block diagram showing another embodiment of an article image data marking apparatus.

FIG. 7 is a flowchart showing operation of the apparatus in FIG. 6.

FIG. 8 is an explanatory view showing an example of an article (gem stone) marked with image data.

### DESCRIPTION OF THE PREFERRED EMBODIMENTS

Embodiments of the present invention will be described by reference to the drawings.

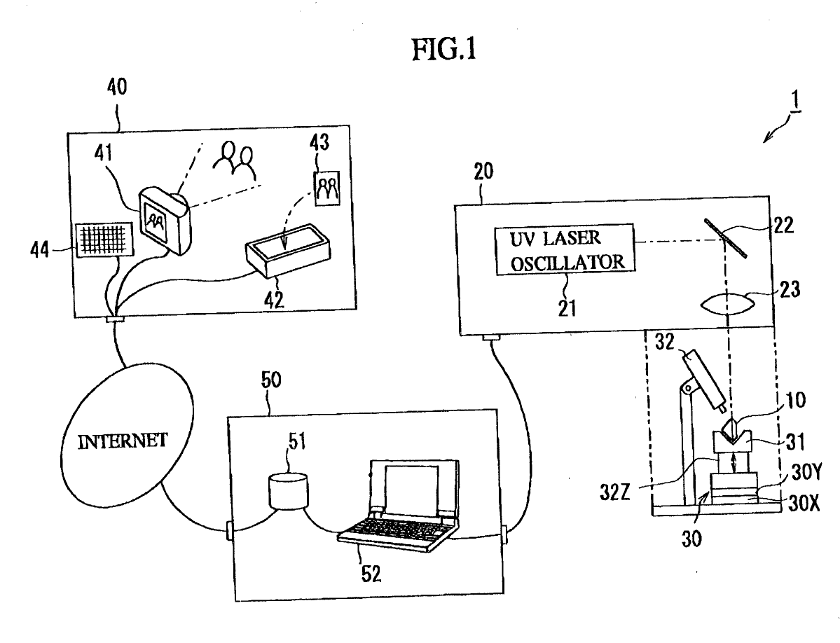

FIG. 1 is a block diagram showing an embodiment of an article image data marking apparatus according to the invention. This image data marking apparatus 1 is for marking image data on a surface of a girdle portion of a gem stone 10 by applying a laser beam to the surface of the girdle portion while controlling output and an application direction according to desired image data. The surface to be marked with data may be another surface of the gem stone 10.

The image data marking apparatus 1 includes a laser output portion 20 and a positioning portion 30 for positioning the laser output portion 20 and the gem stone 10 with respect to each other such that the laser beam output from the laser output portion 20 comes into a focus on the surface of the girdle portion of the gem stone 10.

The image data marking apparatus 1 also includes an image data obtaining portion 40 for obtaining desired image data to be marked and a laser beam control portion 50 for controlling the output and the application direction of the laser beam by controlling operation of the laser output portion 20 based on the obtained image data.

The target gem stones 10 include man-made stones and synthetic stones in addition to natural gem stones such as diamond.

In the above gem stones, the natural gem stones include diamond, corundum (ruby and sapphire), beryl (emerald and aquamarine), chrysoberyl (alexandrite and cat's eye), garnet, quartz, spinel, spodumen, zoisite, topaz, tourmaline, feldspar, peridot, opal, and zircon.

The man-made stones and synthetic stones include man-made diamond, YAG (yttrium aluminium garnet), synthetic emerald, GGG (gadolinium gallium garnet), synthetic quartz, cubic zirconia, synthetic alexandrite, synthetic corundum (synthetic ruby and synthetic sapphire), synthetic spinel, strontitanate, and moissanite.

The laser output portion 20 is formed of a UV laser oscillator 21, a beam scanner 22 such as a galvanoscanner for scanning the laser beam oscillated from the UV laser oscillator 21 in a predetermined direction, and a lens 23 for bringing the laser beam to a focus on a predetermined position. The lens 23 may be an fθ lens or an arc-sin lens depending on a control method of the beam scanner 22 but will be described as the fθ lens in the present embodiment.

The UV laser oscillator 21 oscillates a laser beam of an ultraviolet wavelength of about 0.4 μm or less and it is possible to use an excimer laser (noble gas halide excimer laser). As his type of laser medium, an ultraviolet wavelength of 0.308 μm can be obtained by XeCL (xenon chlorine), an ultraviolet wavelength of 0.248 μm can be obtained by KrF (krypton fluorine), and an ultraviolet wavelength of 0.193 μm can be obtained by ArF (argon fluorine).

The UV laser oscillator 21 for which such an excimer laser (noble gas halide excimer laser) is used is a laser that oscillates only in short pulses of a pulse width of 10 ns or less because life of an excited state of the laser medium is very short. However, because it is possible to obtain a minuscule beam diameter of about 2 μm or less, high-quality marking is possible.

The positioning portion 30 is for carrying out positioning such that a distance between the surface of the girdle portion to be subjected to marking of the gem stone 10 supported on the support table 31 and the fθ lens 23 of the laser output portion 20 agrees with a focal length of the fθ lens 23. For example, the positioning is carried out by moving the support table 31 up or down. In order to provide for a very small gem stone 10, a positioning auxiliary instrument 32 such as a microscope, for example, is provided if necessary. By finely adjusting a height of the support table 31 while checking the position by using the positioning auxiliary instrument 32, accurate positioning can be carried out.

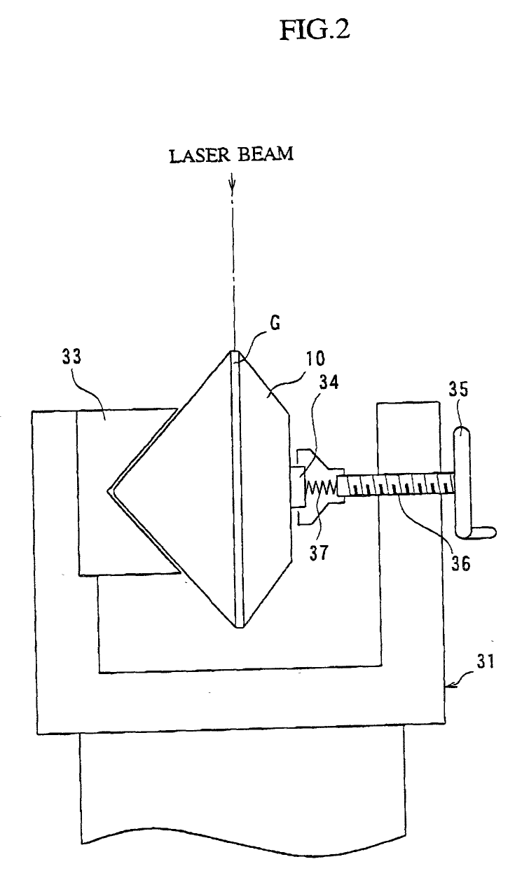

The support table 31 may be formed of a fixed retainer 33 and a movable retainer 34, for example, as shown in FIG. 2. In the movable retainer 34, a screw shaft 36 moves forward or backward when a handle 35 is turned to adjust a space between the movable retainer 34 and the fixed retainer 33. When a predetermined space is set, a tip end of the screw shaft 36 presses the fixed retainer 33 leftward in FIG. 2 through a spring 37 to thereby sandwich the gem stone 10 between the fixed retainer 33 and the movable retainer 34 while the gem stone 10 is oriented sideways. In this state, the gem stone 10 can be retained stably while a surface of a portion to be subjected to marking is oriented upward. In order to ensure this stable retaining, it is preferable that at least tip end portions of the fixed retainer 33 and the movable retainer 34 are formed of elastic material such as rubber.

The image data obtaining portion 40 includes an image data obtaining device such as a digital camera 41 such as a CCD camera for taking a picture of a desired image such as an image of a person to be marked to obtain the image as digital image data or an image scanner 42 for reading a desired picture or prepared picture 43 to be marked to obtain the picture 43 as digital image data. The image data obtaining device is not limited to the above digital camera 41 and image scanner 42 but may be any device for generating image data in such a form as to be read by a laser beam control portion 50 that will be described later. The image information obtaining portion may include an image editor 44 for editing the obtained image data and inputting and editing initials of a person, figures showing a wedding anniversary or the like, or a pattern to create image data for marking.

The marking data created in the image data obtaining portion 40 is transferred to the laser beam control portion 50 via a portable recording medium such as a CD or via the Internet or other telecommunication lines. More specifically, image data, i.e., marking data for marking is made according to a desire of a customer in a store and transferred to the laser beam control portion 50 in a processing plant. It is also possible that the customer has a personal computer and the image data obtaining device to form the image information obtaining portion 40 and transfers image data to the laser beam control portion 50 for himself/herself.

If the image data obtaining portion 40 and the laser beam control portion 50 are adjacent to each other, the marking data can be directly transferred through a connecting cable.

The laser beam control portion 50 is substantially formed of a personal computer and includes a marking data file 51 for storing the marking data transferred from the image data obtaining portion 40 and a data processing portion 52 for reading the marking data from the image data obtaining portion 40 or the marking data file 51 and for processing the marking data according to a predetermined program and the data processing portion 52 controls operation of the laser output portion 20 based on the marking data.

In other words, in the laser beam control portion 50, the data processing portion 52 controls on/off of the output laser beam generated by oscillation of the UV laser oscillator 21 and an application direction by operation of the beam scanner 22 according to the marking data that is the digital image data to apply the laser beam to the surface of the girdle portion of the gem stone 10, thereby marking a desired image or initial letters, figures showing a date of an anniversary, or the like, if necessary, on the surface of the girdle portion of the gem stone 10.

In order to mark minute image data by controlling the application direction by operation of the beam scanner 22, the beam scanner 22 is actuated with predetermined position accuracy. As a driving source for achieving such minute movement, a displacement actuator known as a piezoactuator can be used, for example. Because the piezoactuator can electrically control minute displacement that is substantially 1 μm or less, it is possible to achieve predetermined positioning accuracy of the beam scanner 22 by using the piezoactuator.

By such operation of the beam scanner 22, it is possible to mark the minute image data. It is also possible to minutely move the gem stone 10 along a plane to be subjected to marking in response to movement of the beam scanner 22, if necessary. For example, by providing an X table 30X and a Y table 30Y that can be moved minutely in an X direction and a Y direction orthogonal to each other along a horizontal plane to the positioning portion 30 as shown in FIG. 1 and by minutely moving the respective tables 30X and 30Y with high accuracy by an actuator such as a piezoactuator, highly-accurate and minute movement of the gem stone 10 with the support table 31 can be achieved.

Such movement of the gem stone 10 in response to the movement of the beam scanner 22 can be achieved by a proper controller (not shown) controlled by the data processing portion 52 of the laser beam control portion 50.

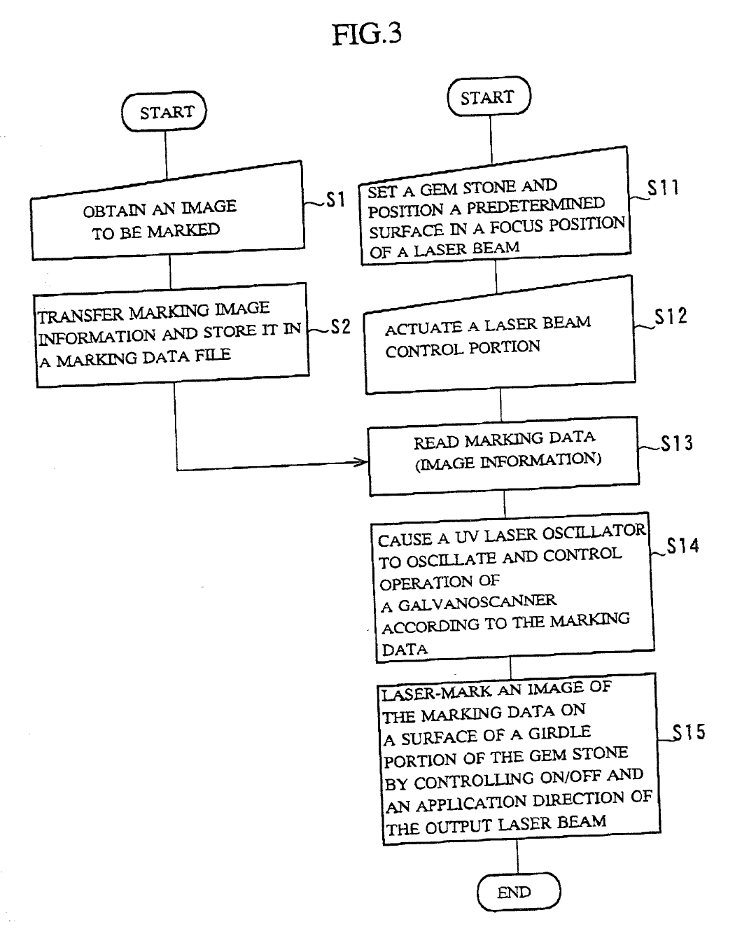

Next, operation of the above embodiment will be described by using a flowchart shown in FIG. 3.

First, an image to be marked on the gem stone 10 such as diamond is obtained by taking a picture by using the digital camera 41 or by reading the image by using the image scanner 42 (step S1). It is also possible to edit the obtained image by using the image editor 44 or to create or edit new patterns or letters.

For example, when a gem stone 10 such as diamond as a commemoration of an engagement, marriage, silver wedding, or the like is subjected to marking, image data such as a recent picture of two concerned people standing or sitting side by side can be used as the marking data and the image data formed by adding initial letters of the two people, letters and figures of a date of a wedding, and the like to the above image data can be used as the marking data.

Next, the marking data created by obtaining or editing is transferred to the laser beam control portion 50 and stored in the marking data file 51 (step S2).

On the other hand, the gem stone 10 such as diamond is set on the support table 31 of the positioning portion 30 and the positioning portion 30 is operated such that the distance between the surface of the girdle portion to be subjected to marking of the gem stone 10 and the fθ lens 23 of the laser output portion 20 agrees with the focal length of the fθ lens to position the relative positions of the gem stone 10 such as diamond and the fθ lens 23 with respect to each other (step S11). At this time, by finely adjusting the height of the support table 31 while checking the position by using the positioning auxiliary instrument 32 such as the microscope and a videoscope, if necessary, positioning accuracy can be improved.

When preparation of the marking data and positioning preparation of the gem stone 10 such as diamond have been completed, the laser beam control portion 50 is actuated (step S12).

Then, in the laser beam control portion 50, the data processing portion 52 first reads the marking data from the marking data file 51 (step S13).

Then, the data processing portion 52 causes the UV laser oscillator 21 to operate to control output strength of the UV laser oscillator 21 and controls operation of the beam scanner 22 (step S14) according to the marking data.

As a result, on/off of the output laser beam by the UV laser oscillator and the application direction of the output laser beam by operation of the beam scanner 22 are controlled according to the marking data to thereby laser-mark the image of the marking data on the surface of the girdle portion of the gem stone 10 such as diamond (step S15).

By controlling the positioning portion 30 in synchronization with operation of the laser output portion 20 and minutely displacing the gem stone 10 along the plane subjected to marking, it is possibly to apply making with higher accuracy. By causing the positioning portion 30 to operate to move the gem stone 10 along the plane to be subjected to marking, it is possibly to apply marking to a wider range while maintaining the positioning accuracy of the laser beam. In this case, it is preferable that a Z table is also caused to operate to finely adjust a focus of the laser beam.

Marking is achieved by causing the laser beam to scan in the embodiment, which is equivalent to causing the laser beam to relatively scan the surface of the gem stone by fixing the beam scanner or replacing the beam scanner by a mirror to fix the laser beam and controlling only the positioning portion 30 that can be displaced in X, Y, and Z directions to thereby achieve the marking similar to the above.

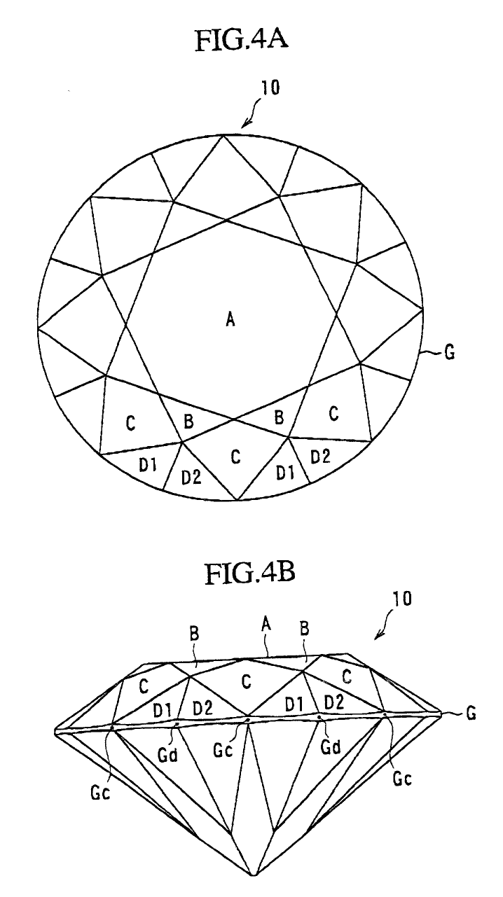

If the gem stone 10 is diamond that is given round brilliant cut as shown in FIGS. 4(a) and 4(b), for example, it is preferable to apply laser marking to surface positions Gc adjacent to tip ends of bezel facets C or surface positions Gd adjacent to tip ends of joining ridge lines of two upper girdle facets D1 and D2 in a girdle G formed on a side face of an entire periphery that continues from a table facet A through star facets B, the bazel facets C, and the upper girdle facets D. This is because the surface positions Gc or Gd are the highest in the girdle G and a possibility that a limitation is imposed to a height of the image to be marked is the smallest in the surface positions Gc or Gd.

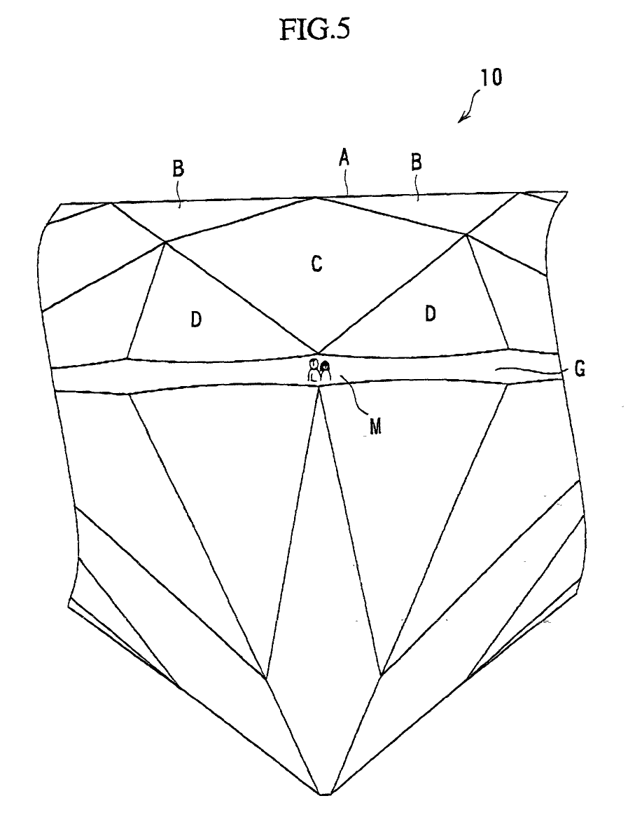

FIG. 5 shows an example in which an image of the recent picture of the two concerned people of commemoration of the engagement, marriage, silver wedding, or the like, for example, is marked as marking data M in the surface position Gc of the girdle G in the diamond that is given the round brilliant cut. A size of the marking data M shown in FIG. 5 is a size in which the marking data M can be seen easily for purposes of illustration and is not an actual size.

The size of the marking data M depends on a size of the gem stone 10 itself such as diamond but is preferably about 50 μm×50 μm to 300 μm×300 μm as a guideline. If the marking data M is in such a size, it is possible to satisfactorily apply marking to the girdle portion of the gem stone 10 such as diamond.

An owner who knows existence of the marking as the commemoration in the girdle portion can see the marking at any time by using a proper tool such as a loupe, for example, and indulge in a feeling of happiness by remembering meaning of the commemoration.

Although the above embodiment shows diamond that is given the round brilliant cut as the gem stone 10 and shows the case in which marking is applied to the surface position Gc adjacent to the tip and of the bezel facet C or the surface position Gd adjacent to the tip end of the joining ridge line between the two upper girdle facets D1 and D2 of the girdle G, the invention is not limited to this. The marking may be applied to an arbitrary surface position other than the surface positions Gc and Gd on the girdle G. Such a case is suitable for marking a wide image. In a case of an arbitrary cut (e.g., emerald cut) other than the round brilliant cut, it is possible to apply marking to an arbitrary surface position on a girdle G.

Although the above embodiment shows diamond as the gem stone 10 and shows marking on the girdle G, the invention is not limited to this. For example, some kinds of gem stones 10 do not have portions called “girdles”. In such a case, by choosing a proper surface position out of surfaces of the gem stone where presence of a slight flaw does not substantially affect quality and by applying marking to the surface position, similar effects can be obtained.

In the invention, the position where the marking is applied is not limited to the girdle G when the gem stone 10 is the diamond that is given the round brilliant cut. In other words, in the diamond that is given the round brilliant cut as shown in FIGS. 4(a) and 4(b), it is also possible to apply marking to the table facet A as well as the star facets B, the bezel facets C, and the upper girdle facets D.

In the above facets, the table facet A is a face in which a flaw may be the most conspicuous. However, the marking that is rated as a blemish, i.e., not rated as a flaw in a strict sense and not substantially rated as a flaw by a diamond appraisal institution does not substantially affect quality of the diamond. In this case, it is possible to use the table facet A as the marking position.

Not only on the table facet A but also on the star facets B, the bezel facets C, the upper girdle facets D, the girdle G, and all other faces, a degree of conspicuousness of the marking is preferably such a degree that the marking is rated as the blemish. However, because the marking is less conspicuous on the other faces than on the table facet A, the marking that is rated as a flaw that is more conspicuous than the blemish is acceptable according to the small degree of conspicuousness if the marking is in such a range as not to substantially affect quality of the diamond. Furthermore, even if the marking is out of such a range as not to substantially affect quality, the marking may be acceptable depending on conditions.

Surface Non-Damaging Marking

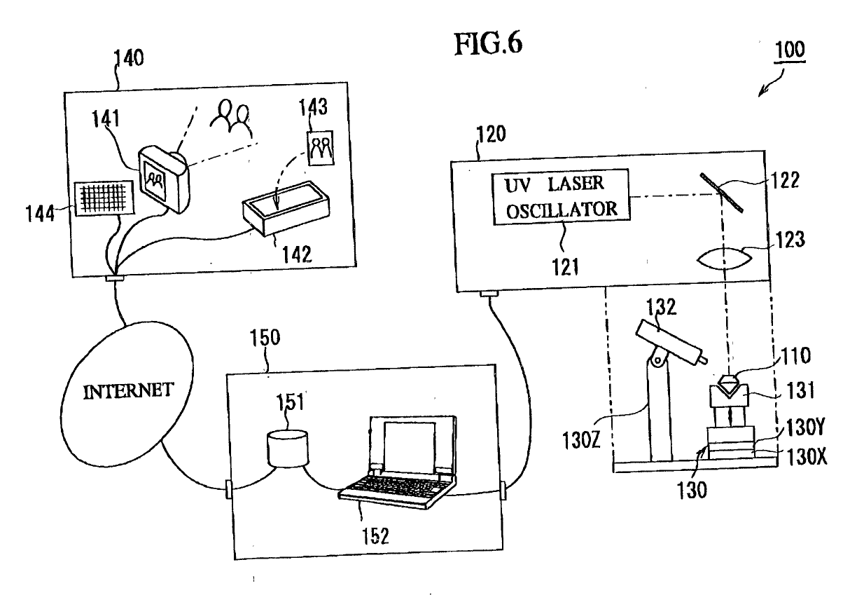

FIG. 6 is a block diagram showing another embodiment of an article image data marking apparatus according to the invention. This image data marking apparatus 100 is for creating a marking on a portion without substantially damaging a surface by applying a laser beam to a transparent or translucent gem stone 110 while bringing the laser beam to a focus on the portion that is at a necessary inward distance from the arbitrary surface.

Therefore, the image data marking apparatus 100 has a structure similar to that in the embodiment shown in FIG. 1 except that a positioning portion 130 positions relative positions of a laser output portion 120 and the gem stone 110 with respect to each other so as to bring a laser beam output from the laser output portion 120 to a focus on the portion that is at the necessary inward distance from the arbitrary surface of the gem stone 110. Therefore, detailed explanation of respective portions will be omitted.

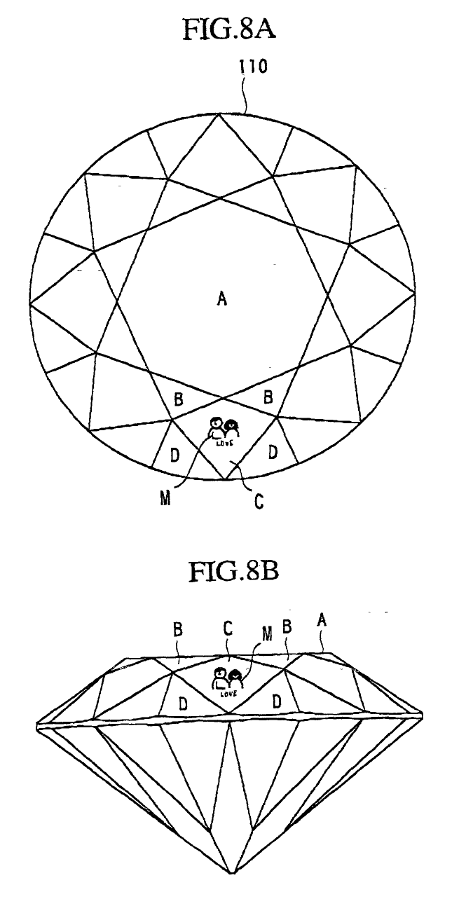

The portion of the gem stone 110 to be subjected to marking is preferably an inside of the star facet B, the bezel facet C, or the upper girdle facet D because a marking in an inside of the table facet shown with A in FIG. 8 may be conspicuous in a case of diamond that is given round brilliant cut, for example. In the above facets, it is preferable to apply marking to the portion that is at the necessary inward distance from the surface of the bezel facet C as shown in FIG. 8.

However, it is possible to apply marking to the portion that is at the necessary inward distance from every surface including the table facet A. The marking that is rated as a blemish (i.e., not rated as a flaw in a strict sense and not substantially rated as a flaw) by the diamond appraisal institution does not substantially affect quality of the diamond. Therefore, it is possible to use the table facet A as the marking position in this case.

Not only on the table facet A but also on the bezel facets C and all other faces, a degree of conspicuousness of the marking is preferably such a degree that the marking is rated as the blemish. However, because the marking is less conspicuous on the other faces than on the table facet A, the marking that is rated as a flaw that is more conspicuous than the blemish is acceptable if the marking is in such a range as not to substantially affect quality of the diamond. Furthermore, even if the marking is out of such a range as not to substantially affect quality, the marking may be acceptable depending on conditions.

In cases of diamond that is given cut other than the round brilliant cut and other gem stones, it is similarly preferable to apply marking to a position where the marking is less conspicuous when the gem stone is seen from right above, i.e., a position that is seen slightly diagonally or the girdle portion while not applying marking to a face where the marking is conspicuous when the gem stone is seen from right above. However, if the marking is rated as the blemish or the like, the marking does not substantially affect quality of the gem stone. Therefore, the face such as the table facet where the marking may be conspicuous when seen from right above may be used as the marking portion.

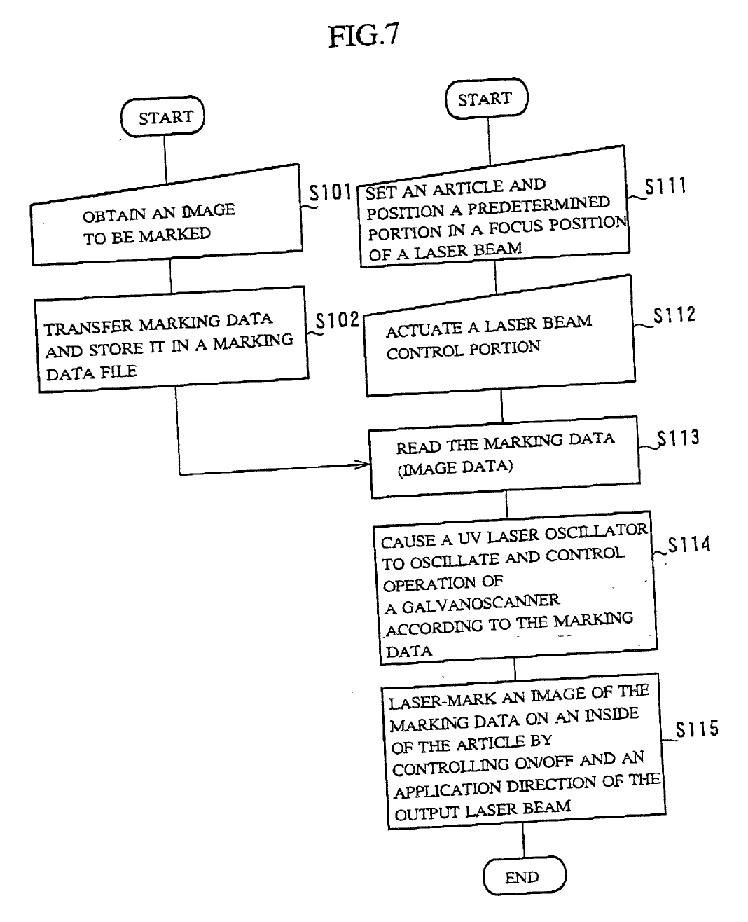

Next, operation of the above embodiment will be described by using a flowchart shown in FIG. 7.

First, similarly to step S1, an image to be marked on the gem stone 110 such as diamond is obtained by taking a picture by using a digital camera 141 or by reading the image by using an image scanner 142 (step S101). It is also possible to edit the obtained image by using an image editor 144 or to create or edit new patterns or letters.

Next, the marking data created by obtaining or editing is transferred to the laser beam control portion 150 and stored in a marking data file 51 (step S102).

On the other hand, the gem stone 110 such as diamond is set on a support table 131 of the positioning portion 130 and the positioning portion 130 is operated such that a distance between a portion subjected to marking at a predetermined inward distance from an arbitrary surface of the gem stone 110 and an fθ lens 123 of the laser output portion 120 agrees with a focal length of the fθ lens 123 to position the relative positions of the gem stone 110 such as diamond and the fθ lens 123 with respect to each other (step S111).

If the gemstone 110 is diamond that is given round brilliant cut, for example, the bezel facet C, for example, to be subjected to marking is oriented to be perpendicular to the laser beam and positioning is carried out so as to bring the fθ lens 123 a focus on the position at the necessary inward distance from the surface of the bezel facet C. At this time, by finely adjusting the height of the support table 131 while checking the marking position and the focus position by using a positioning auxiliary instrument 132 such as a microscope and a videoscope, if necessary, positioning accuracy can be improved.

When preparation of the marking data and positioning preparation of the gem stone 110 such as diamond have been completed, the laser beam control portion 150 is actuated (step S112).

Then, in the laser beam control portion 150, the data processing portion 152 first reads the marking data (image data) from the marking data file 151 (step S113).

Then, the data processing portion 152 causes the UV laser oscillator 121 to oscillate to control oscillation of the UV laser oscillator 121 and controls operation of the beam scanner 122 according to the marking data (stop S114).

As a result, on/off of the output laser beam by the UV laser oscillator and the application direction of the output laser beam by operation of the beam scanner 122 are controlled according to the marking data to thereby laser-mark the image of the marking data on the marking portion at the predetermined inward distance from the surface of the gem stone 110 such as diamond (step S115).

By controlling the positioning portion 130 in synchronization with operation of the laser output portion 120 and minutely displacing the gem stone 110 along the plane subjected to marking, it is possibly to apply marking with higher accuracy. By causing the positioning portion 130 to operate to move the gem stone 110 along the plane to be subjected to marking, it is possibly to apply marking to a wider range while maintaining the positioning accuracy of the laser beam. In this case, it is preferable that a Z table is also caused to operate in response to operation of the laser output portion 120 to finely adjust a focus position of the laser beam.

If the gem stone 110 is the diamond that is given the round brilliant cut, for example, an image of a recent picture of two concerned people of commemoration of an engagement, marriage, silver wedding, or the like, for example, is laser-marked as marking data M in the marking portion at the necessary inward distance from the surface of the bezel facet C as shown in FIGS. 8(a) and 8(b).

Illustrations of FIGS. 8(a) and 8(b) are symbolic and do not show how long is the marking data M inward from the surface of the bezel facet C. Although the marking data M is shown at an angle of FIG. 8(a) in which the gem stone is seen from just above and at an angle of FIG. 8(b) in which the gem stone is seen just from a side, this does not mean that the marking data M can be seen as shown in FIGS. 8(a) and 8(b) when the gem stone is seen at any angles but means that the marking data M can be seen when the bezel facet C is seen perpendicularly. A size of the marking data M shown in FIGS. 8(a) and 8(b) is a size in which the marking data M can be seen easily for purposes of illustration and is not an actual size.

The size of the marking is preferably in a range of a flaw of a VS₂ rank according to a standard of G.I.A. (Gemmological Institute of America) as a guideline in a case of diamond because such a size does not affect beauty of the diamond when seen with naked eyes.

Moreover, if such a marking is applied to the surface of the gem stone 110 such as diamond, the marking can be found relatively easily with naked eyes even if the marking is small. Therefore, the marking is fully expected to affect beauty of the diamond. However, because the marking according to the invention is formed inside the gem stone 110 such as diamond as described above and also because the marking is small, the marking cannot be found if a person who sees the gem stone does not know the presence of the marking and does not watch the gem stone extremely carefully. Therefore, it is hardly possible that the marking impairs beauty of the diamond.

Furthermore, an owner who knows existence of the marking as the commemoration inside the gem stone can see the marking by only using a proper tool such as a loupe, for example, but at any time and indulge in a feeling of happiness by remembering meaning of the commemoration.

Although the marking is created without damaging the surface of the gem stone 110 such as diamond in the above second embodiment, the invention is not limited to this. Even if the surface is damaged extremely slightly in applying laser-marking to an inside, such a marking is included in a scope of the invention if the damage is not substantially judged to be a flaw such as a flaw that cannot be seen well or a flow in such a size to be ignored.

The invention is not limited to the gem stone 110 such as diamond and the articles (gem stones) 110 include gem stones such as diamond, man-made and synthetic stones, glass, crystal ware, plastic ware, and ceramic ware.

In the above articles, the gem stones such as diamond include diamond, corundum (ruby and sapphire), beryl (emerald and aquamarine), chrysoberyl (alexandrite and cat's eye), garnet, quartz, jade, spinel, spodumen, zoisite, topaz, tourmaline, natural pearl, cultured pearl, feldspar, peridot, opal, amber, and zircon.

The man-made and synthetic stones include man-made diamond, YAG, synthetic emerald, GGG, synthetic quartz, cubic zirconia, synthetic alexandrite, synthetic corundum (synthetic ruby and synthetic sapphire), synthetic spinel, strontitanate, and moissanite.

Furthermore, the glass, crystal ware, plastic ware, and ceramic ware include tableware, bibelots, ornaments, lens, chemical laboratory wares, wares for glasses, wares for a clock, and souvenirs such as key rings, windowpanes for buildings, vehicles, and flying objects, mirrors, and containers for drinks, cosmetics, medicines, and the like.

Although the above first and second embodiments show the case in which the marking is applied to the gem stone 10 or 110 such as diamond as the commemoration of the engagement, marriage, silver wedding, or the like, the invention is not limited to this and is also suitable for applying marking to a gem stone 10 or 110 as a commemoration of conferment or other social honors. In any cases, it is possible to permanently leave meaning of the commemoration on such an arbitrary surface (e.g.. the surface of the girdle portion) as not to affect quality of the gem stone 10 such as diamond.

Although the excimer laser (noble gas halide excimer laser) is employed as the UV laser oscillators 21 and 121 in the above first and second embodiments, the UV laser oscillators 21 and 121 are not limited to this and proper laser medium can be used as long as necessary properties of a wavelength and a beam diameter can be obtained by the laser medium.

For example, a third harmonic of a wavelength of 0.355 μm formed by mixing a YAG laser light (wavelength of fundamental of 1.064 μm) that is a solid laser and a second harmonic (wavelength of 0.532 μm) formed of wavelength-exchange crystals may be used.

As described above, because the invention has such a structure that image data is marked on an arbitrary surface of an article (gem stone) by applying a laser to the surface according to the desired image data while controlling output and an application direction so as not to substantially affect quality of the article (gem stone), it is possible to leave meaning of a commemoration on the arbitrary surface of various articles (gem stones) such as diamond by applying the intention to an article (gem stone) as a commemoration of an engagement, marriage, silver wedding, or the like and an article (gem stone) as a commemoration of conferment or other social honors.

Furthermore, because marking is formed of image data, meaning of a commemoration can be expressed by richer content than information such as simple letters and figures, for example. As a result, the invention can achieve the highest customer satisfaction for an owner of the commemoration as an unmatched commemoration with the scarcest value.

The present disclosure relates to subject matter contained in priority Japanese Application Nos. 11-371890, filed Dec. 27, 1999; 2000-28238, filed Feb. 4, 2000; 2000-343500, filed Nov. 10, 2000; and 2000-343511, filed Nov. 10, 2000, the contents of all of which are herein expressly incorporated by reference in their entireties.

We claim:

1. A method for marking predetermined image data on an arbitrary surface of an article, wherein a laser beam is applied to said surface while controlling output and an application direction so as not to substantially affect quality of said article according to said predetermined image data.

2. A method for marking predetermined image data on an arbitrary surface of an article, said method comprising the steps of:
obtaining a predetermined image to be marked as digital image data;
relatively positioning a laser output device and said article with respect to each other such that a laser beam comes into a focus on said surface; and
creating a marking on said surface by causing said laser output device to operate and applying said laser beam according to said digital image data while controlling output and an application direction so as not to substantially affect quality of said article.

3. A method according to claim 1 or 2, wherein said article is a gem stone and said surface is a girdle portion.

4. A method according to claim 1 or 2, wherein said article is a gem stone, said arbitrary surface is at least a table facet, and a marking that can be rated as a blemish is created.

5. A method for marking predetermined image data in a portion at a necessary inward distance from an arbitrary surface of a transparent or translucent article, said method comprising the step of creating a marking in said portion without substantially damaging said surface by applying a laser beam while bringing said laser beam to a focus on said portion according to said predetermined image data.

6. A method for marking predetermined image data in a portion at a necessary inward distance from an arbitrary surface of a transparent or translucent article, said method comprising the steps of:
obtaining a predetermined image to be marked as digital image data;
relatively positioning a laser output device and said article with respect to each other such that a laser beam comes into a focus on said portion; and
creating a marking in said portion by causing said laser output device to operate and applying said laser beam according to said digital image data while controlling output and an application direction so as not to substantially damage said surface.

7. A method according to claim 5 or 6, wherein said article is a gem stone and a marking that can be rated as a blemish is created on said surface.

8. An apparatus for marking predetermined image data on an arbitrary surface of an article, said apparatus comprising:
means for obtaining said image data;
laser output means;
means for relatively positioning said laser output means and said article with respect to each other such that a laser beam comes into a focus on said surface; and
control means for causing said laser output means to operate and applying said laser beam according to said image data while controlling output and an application direction so as not to substantially affect quality of said article.

9. An apparatus for marking predetermined image data in a portion at a necessary inward distance from an arbitrary surface of a transparent or translucent article, said apparatus comprising:
means for obtaining said image data;
laser output means;
means for relatively positioning said laser output means and said article with respect to each other such that a laser beam comes into a focus on said portion; and
control means for causing said laser output means to operate and applying said laser beam according to said image data while controlling output and an application direction so as not to substantially damage said surface.

10. An apparatus according to claim 8 or 9, wherein said means for obtaining said image data further includes image data editing means.

11. An apparatus according to claim 8 or 9, wherein said article is a gem stone and said surface is a girdle portion.

12. A system for marking predetermined image data in an arbitrary portion of an article according to a desire of a customer, said system comprising:
an image information obtaining portion for creating said image data desired by said customer;
a laser output portion including a laser oscillator;
a positioning portion for relatively positioning said laser output portion and said article with respect to each other such that a laser beam of said laser oscillator comes into a focus on said portion; and
a control portion for causing said laser output portion to operate and applying said laser beam according to said image data while controlling output and an application direction so as not to substantially affect quality of said article.

13. A system according to claim 12, wherein said arbitrary portion is a portion at a predetermined inward distance from an arbitrary surface of said article.

14. A system according to claim 12, wherein said image information obtaining portion is disposed at a place separated from said system and said image data is transferred from said image information obtaining portion through a telecommunication line to said control portion.

15. A gem stone whose arbitrary portion is marked with predetermined image data,
wherein a laser beam is applied to said portion according to said predetermined image data; and
said laser beam is applied while controlling output and an application direction so as not to substantially affect quality of said gem stone.

16. A gem stone whose arbitrary portion is marked with predetermined image data,
wherein a laser beam is applied to said portion according to said predetermined image data; and
said laser beam is applied from a laser output device positioned so as to bring said laser beam to a focus on said portion while controlling output and an application direction so as not to substantially affect quality of said gem stone.

17. A gem stone according to claim 15 or 16, wherein said arbitrary portion is at least a table facet and a marking that can be rated as a blemish is created.

18. A gem stone according to claim 15 or 16, wherein said arbitrary portion is a portion at a predetermined inward distance from an arbitrary surface of said gem stone.

19. A gem stone according to claim 18, wherein said surface is a girdle portion.
